(19) United States
(12) Patent Application Publication
(10) Pub. No.: US 2013/0312076 A1
(43) Pub. Date: Nov. 21, 2013

(54) DEVICE AND METHOD FOR PROVIDING AUTHENTICATED ACCESS TO INTERNET BASED SERVICES AND APPLICATIONS

(71) Applicants: Mario Houthooft, Sint-Martens Latem (BE); Dieter Houthooft, Melle (BE)

(72) Inventors: Mario Houthooft, Sint-Martens Latem (BE); Dieter Houthooft, Melle (BE)

(73) Assignee: LIN.K.N.V., Melle (BE)

(21) Appl. No.: 13/982,150

(22) PCT Filed: Jan. 26, 2012
(86) PCT No.: PCT/BE12/00001

§ 371 Date: Jul. 26, 2013

(30) Foreign Application Priority Data
Jan. 26, 2011 (BE) 2011/0043

(51) Int. Cl. G06F 21/41

(52) U.S. Cl. CPC G06F 21/41
USPC 726/8

(57) ABSTRACT

Device for providing an authenticated access to the Internet based services, which is remarkable in that it comprises a unified identity management system (2), which is centered on the user (3) for generating a unified identity means (23) intended for users (3) within a particular area, so that this user is able to use the same account to make himself known and to authenticate this for various applications (31, 32, 33, 34, 61), possibly based on different application owners (63); and associated method therefor.

### FIELD OF THE INVENTION

This invention relates to an “Internet” system, which is supported on a device for providing an authenticated access to Internet supported services and applications.

### BACKGROUND OF THE INVENTION

Conditions wherein a user is in possession of a multiplicity of passwords in order to gain access to a wide variety of websites are in fact known to cause a problem for the user, in that it eventually becomes somewhat difficult for the user to remember the passwords properly in order for them to be used correctly with regard to a required website. To remedy this, a number of management systems have been developed which provide access to a multiplicity of computers via the Internet by means of one single authentication process.

### STATE OF THE ART

A system of this type is known from WO 2009/018564. A single-sign-on user account known as SSO is described herein, as well as a set of websites with protected access which are linked to the aforementioned SSO user account, and various user identification IDs and password combinations that are linked with the aforementioned set of access-protected websites. A computer program which is installed on a local computer is conFig.d to enter immediately in advance the log-in and password intended for the access-protected websites.

A further system is also described in WO 2008/024454, in which a trusted platform module referred to as TPM is described, which interworks with a PROXY SSO unit and with access applications to the web to generate, store and search for passwords in SSO credentials. The same problem is again raised herein that the user is confronted with a constantly growing number of passwords every time he wishes to gain access to a new website or wishes to re-activate a specific website.

With the constant increase in electronic transactions and all kinds of Internet-related operations, the protected use of a suitable identification during the operations on the Internet has become a critical problem that resulted in the setting up of Internet models for the identification and management of the user, who is normally registered with a well-defined username and password linked to a specific domain, with the aim of hindering theft or even any unauthorised use of the identification by a third party from site to site. Models of this type, referred to here as application-oriented identity models, are characterised by a strong support for domain management, but nevertheless reveal scaling and flexibility limitations as soon as they are faced with more extensive identity requirements of Internet scenarios.

Known authentication systems tend to be oriented on an application basis, revealing the disadvantage that they entail severe limitations for both users and agents or service providers of the aforementioned applications. The latter at any rate remain locked into one authentication method or technology to which they are restricted. Furthermore, they have an increasing total cost of ownership (TCO) in facilities, from maintaining a helpdesk and the like. The latter also have to contend with the quality of the user data, such as problems of double use, false data, or even data that are no longer current. In addition, they have little or no reciprocal exchange among the applications, no cross-marketing or cross-costing known as TCO. Furthermore, they must provide support for privacy conformity.

As far as the users are concerned, they are somehow forced to use specific authentication means dedicated to the application. Furthermore, they experience difficulties in maintaining their credentials. They are similarly unable to enjoy multiple reciprocal authentication/application interaction. Finally, they reveal an increasing concern relating to the control and management of their identity, their credentials and their privacy.

### THE AIM OF THE INVENTION

The object of the present invention is likewise to find a solution to the aforementioned drawbacks and problems, but in a more sophisticated manner that is based on an innovative combination of a number of elements, resulting in a more powerful system thanks to which highly practical and inventive applications using the possibilities of the Internet are created thanks to a user-oriented identity management system.

### DISCLOSURE OF THE INVENTION

According to the present invention, a system is thus proposed as defined in the attached main claim which is based on a combination of validation means such as agreements defined between the service provider of this system and owners or operators of the Internet sites concerned in their capacity as suppliers, such as banks, shopping sites and utility companies whose aim is to provide the user with the possibility of access when said user visits an Internet site that is connected to the central management system concerned, referred to as “LinkID”, which is subject to a connection to the aforementioned management system.

The characteristic feature of user-oriented electronic identification is that the user is able to use one ID that can be both transparent and flexible, instead of having to use a plurality of username/password pairs to be able to get registered with the required websites. This at any rate offers the significant advantage that these operations then also run much more smoothly and the risk of forgetfulness or errors is minimised. User-oriented electronic ID models tend to be geared towards the user himself, and not towards a directory. This also requires identified transactions between users on the one hand, and agents of the websites on the other hand, who then also use controllable data, as a result of which more readily traceable operations are provided. This user-oriented model is based on the concern of providing the users with a means for controlling the manner in which their identity data are forwarded to service providers or agents, wherein the latter furthermore allow the users to have a flexible interaction with a wide variety of services.

In contrast to the aforementioned disadvantages of the known prior art, the so-called linked identity management system according to the invention, which is oriented towards the user, does not present any of the aforementioned limitations of the application-oriented management system models. Instead, it creates new service possibilities for the application owners or operators, and offers user-friendly access to more useful applications by the users.

For the agents or application providers, this means that they can use both present and future authentication methods and technologies for a significantly lower TCO. They also make no investment in infrastructure or equipment. Furthermore, they enjoy an increased quality of the user data, namely elimination of double use, updated correction of the data and the like. Furthermore, there is a complete reciprocal interaction of the attributes with one another, including cross-marketing and cross-selling, with the advantage that a larger number of users are online with more work.

The confidentiality requirements are perfectly maintained and observed. Scalability is also provided, along with an integrated helpdesk and auditing.

As far as the users are concerned, they have more convenient and also more reliable access to online applications, including the payment transactions that use authentication means of their choice. Furthermore, they have a more secure and simple multi-authentication/application interaction with one another. Finally, they enjoy full control and independent management of their identity, credentials and confidentiality.

According to an advantageous embodiment of the present invention, a range of different authentication means can be used, such as a card reader or a mobile telephone to provide access to the aforementioned Internet site connected to the management system according to the invention. This system thus provides an extremely secure service that offers a flexible and strong authentication with a plurality of means, and also the validation of data and transactions intended for signing or payments. These service means, which are exclusively based on standard means, fit in flexibly with any other existing and future applications.

According to an additional embodiment of the present invention, a number of management means are provided with attributes which are intended to determine the profile of the user, such as an address, date of birth and gender, wherein management means thereof are provided in the system according to the invention to extract and store the aforementioned attributes during the course of routine use of the invention. Thanks to the thus proposed system according to the invention, the problem is solved consisting in the improvement method of the protection of SSO user accounts.

A user can thus link a number of attributes as part of his user profile. This attribute can form any given information element relating to the user. Access control is often carried out by linking up the aforementioned attributes notified by a user or by having them checked against a set of rules determined by the service provider or agent. In this respect, the aforementioned attributes can yet be determined in any given manner, provided however that they are understood and interpreted appropriately and analogously by both the user and the service provider or agent in a transaction.

The system according to the invention thus forms a standard supported management system for the management of a standard supported user-oriented electronic identity and credential.

The identity-linked system according to the invention is a reliable and secure user-oriented management system of the user's electronic identity and credential means, with which the users are placed in full control of their identity and privacy, while they simultaneously also offer the possibility to application operators, major trademark proprietors and member companies to build deeper, more relevant, and ultimately more advantageous relationships with the users of their services.

The system according to the invention furthermore also opens the door to a multiplicity of applications as well as cross-selling and cross-marketing with increased revenues. The same account can in any event be used for all work, ranging from normal membership to forum work and purchases or accessions.

This invention also relates to a device intended to carry out the method concerned as set out above, comprising the basic embodiment to carry out the Link-ID method.

Further features and particularities of the invention are defined in corresponding appended subclaims.

Further details are set out more in detail in the description hereinafter which is illustrated by means of the appended drawings.

### BRIEF DESCRIPTION OF THE DRAWINGS

FIG. 1 shows a block diagram of a conventional application-oriented identity model management system from the known prior art.

FIG. 2 shows a block diagram of a conventional user-oriented identity model according to a basic main embodiment of the management system.

FIG. 3 shows a block diagram of a variant of an identity model from the prior art.

FIG. 4 shows a block diagram of a variant of a user-oriented identity model management system.

FIG. 5 is a schematic presentation of the identity components used in the management system according to the invention.

FIG. 6 is a schematic presentation of the parties involved in the management system according to the invention.

FIG. 7 is a flow diagram as a schematic representation of the operation of the management system according to the invention.

FIG. 8 shows a block diagram of a conventional application-oriented identity model according to a particular application example of the invention.

FIG. 9 is a schematic presentation of an examplary embodiment of the method according to the invention.

FIG. 10 shows a block diagram of an application-oriented identity model according to an additional application example according to the invention.

### DESCRIPTION

In general, this invention relates to dedicated authentication systems that differ from the known systems 1 in that the latter are oriented on an application basis with the disadvantage of entailing severe limitations, both for users 3 and for agents or service providers of the aforementioned applications, as shown in FIG. 1. This shows the condition wherein a user 3 possesses one specific identity 13, 14, 15 for each online application a, b, c, possibly operated by the same owner, wherein the respective specified identities 13, 14, 15 may also differ in specific cases. Three identity fields 13, 14, 15 are thus to be considered.

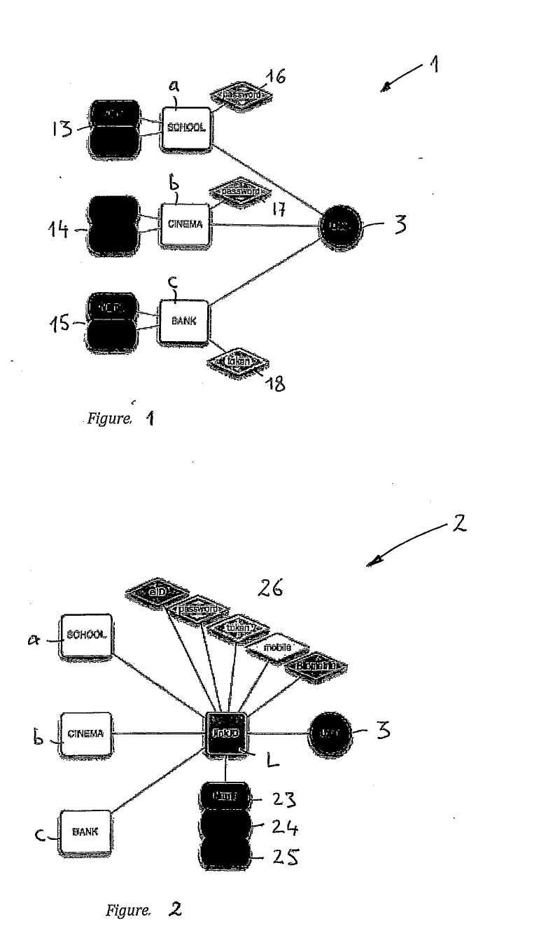

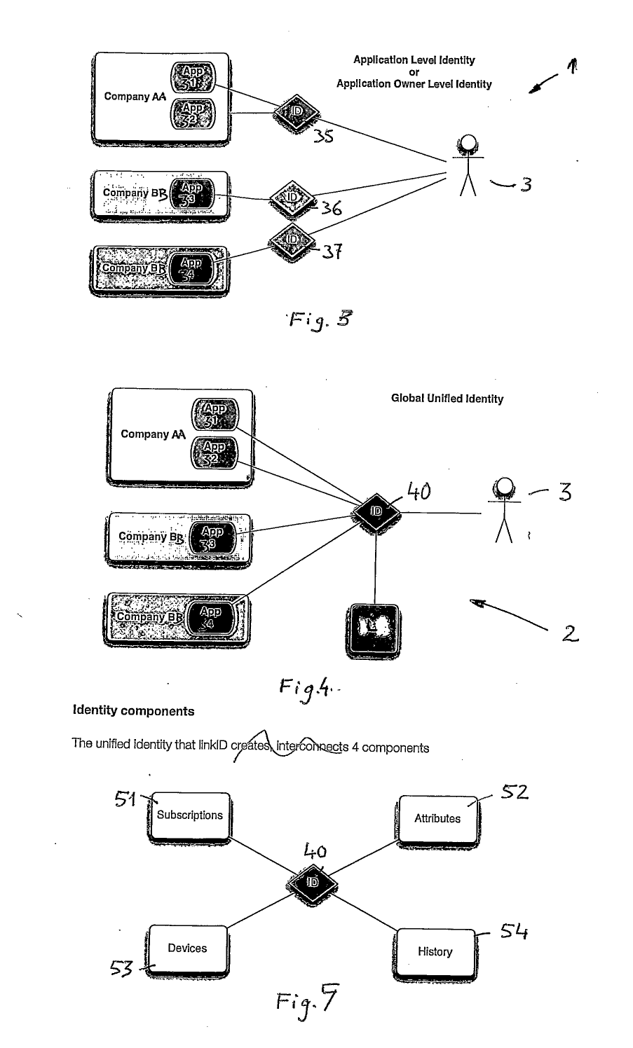

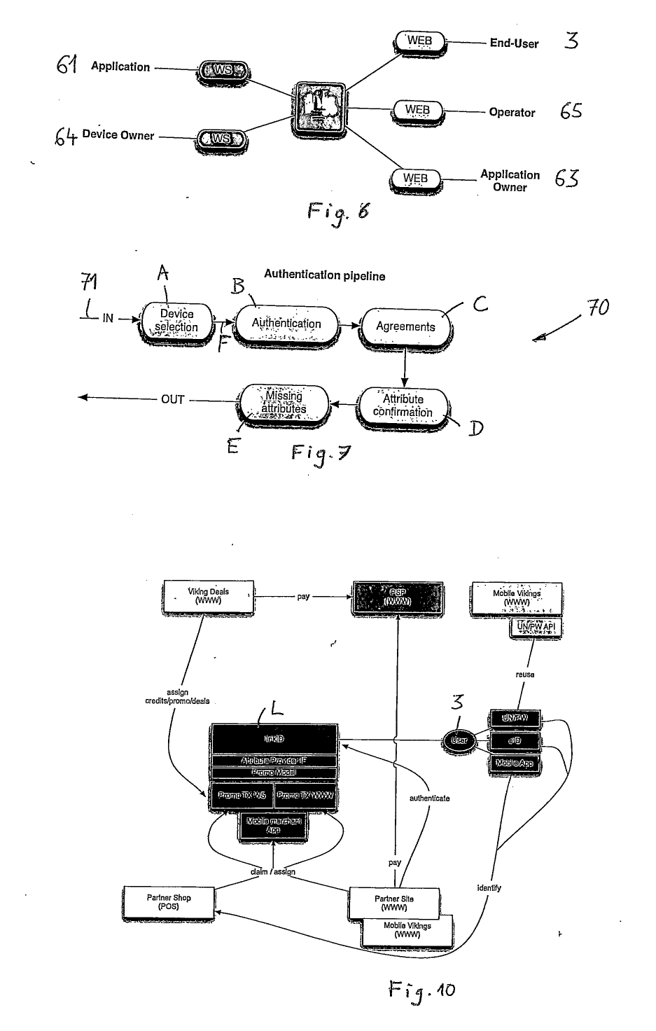

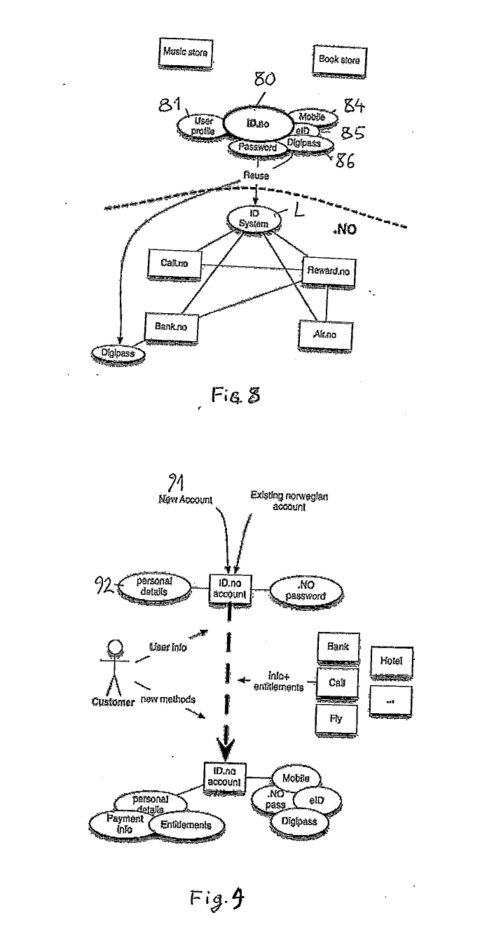

In contrast, the linked identity management system 2 which is oriented towards the user 3 shown in FIG. 2 presents none of the aforementioned limitations of the application-oriented models of the management system 1. Instead, this creates new service possibilities for application owners or operators and offers user-friendly access to more useful applications by the users 3.

The management system 2 forms a unified identity management system which is oriented towards the user 3, and the aim of which consists in creating a unified identity model 23 intended for users within a specific region or industry. This user is therefore able to use the same account to identify himself and authenticate this for different applications a, b, c, wherein these applications can originate from different application owners. This is shown schematically in FIG. 2 with reference to the schematic representation of the current condition shown in FIG. 1.

In the additional example shown in FIG. 3, applications 31 and 32 are operated by the same owner AA, wherein they can share the same identity 35. Herein, the user 30 has one specific identity 35, 36, 37 for each online application 31, 32, 33, 34 separately, possibly operated by the same owner AA or BB, wherein the respective specified identities 35, 36, 37 may differ from one another. In any event, a minimum of 3 identity fields 35, 36 and 37 are to be considered with this example.

The user-oriented management means L according to the invention offers a multiplication of the existing system by offering a unified identity field 40 that can thus be used for the aforementioned applications 31, 32, 33, 34 simultaneously, which can also be operated by a plurality of aforementioned application owners AA or BB, as shown in FIG. 2.

The main embodiment of the invention can thus be determined as a management system L of the identity fields 40 of a user 3 who is identified by one global unified identity 40 which he must enter in order to gain access to his required applications 31, 32, 33, 34 which are operated by agents AA, BB, which is noteworthy in that this management system 2 is oriented towards the user 3, wherein the latter can gain access to all of the aforementioned applications 31, 32, 33, 34 which differ from one another, via one single identity field 40 which uniquely identifies the aforementioned user.

The advantage thereof is clearly that a global unified identity field 40 is obtained thanks to the system 2.

Identity components 51, 52, 53, 54 thus arising intervene in the unified identity 40 which is created by this system 2 and comprise four different components which are all connected via the core element L, shown schematically in FIG. 5.

The first component consists of so-called attributes 52, consisting of pieces of data which have been allocated to the physical person who possesses the identity concerned in his capacity as user 3, such as name, age, gender, town, etc. A further component consists of subscriptions 51 which determine the applications 31, 32, 33, 34 in which the identity 40 concerned can be used. These accessions 51 form the link between an application and an identity. These similarly control the legal and confidentiality compliance between a user and an application that the latter wishes to use.

A further component concerns the authentication means 53 which are intended to be registered and used by a user 3 to authenticate himself. Here, one specific identity 40 may have registered a plurality of authentication means, and examples of this are the username/password pair, an identity card, a conventional credit card, a mobile telephone, etc.

Finally, there is the historical component 54, wherein the user 3 can keep track of all actions relating to his identity 40.

The management system 2 can guarantee the uniqueness of the user 3 by means of his devices 53, on the understanding that the core L will not allow a physical device to be used for two different accounts, thereby making the identities in this management system 2 particularly strong.

Attributes 52 form the substance of the identity 40 of the user 3, and make the user what he ultimately is. The essence of attributes lies in their repeated use between different applications 31, 32, 33, 34, wherein the user can check at any time which application provides access to which attribute.

Attributes 52 have defined data types, such as e.g. Boolean or string characters, and can be linked to single or even multiple values. The attributes can also be combined to form new data types, e.g. a street combined with a town/city together form the address. It should be noted that attributes are not hard-coded but can be added by the operator at the request of its customers, i.e. the application owners.

In the general structure of the system 2, there is the noteworthy core element L thereof, which assumes a central position therein, wherein it communicates with different parties which are determined as follows, as shown in FIG. 6. End users 3 are formed by physical persons who have an account and who wish to use applications 61 which are linked to the core L of the management system 2. The end users interact with the system core L by means of an interface 62, e.g. a web interface, wherein integration with non-web systems is also possible.

A further party is formed by the applications 61, which are intended to perform functions consisting in specific services which are offered to the aforementioned end users 3. In order to be able to identify their users 3, they then use the aforementioned core L. In order to communicate with the core L, they use web services 62.

There are also application owners or operators 63 who own and operate the aforementioned applications. They are the actual customers of a core operator 64. They enter into interaction with the core L by means of a web application which provides statistics and accounting relating to the applications which they own.

Furthermore, there are also the operators 65 who manage the system software in so-called data centres and who sell the various system functions and services to the aforementioned application owners 63. Here, they work together with the aforementioned application owners to have their applications 61 connected to the management system L.

Finally, there are also the device suppliers who supply the necessary authentication means 53 to the users 3. They can have their device 53 carried by the management system 2, which is understood to mean that this is formed by the LinkID system.

Attribute values can be obtained by the user himself 3, by an application 61, by a device 53, a remote system such as a database, a web service, LDAP, or also from a calculation of other attributes. An attribute can be read in by an application 61 if the following conditions are met, namely that the operator gives the application access to the attribute, the user 3 gives permission to the application 61 to use the attribute and finally that the attribute has a value. A further advantageous characteristic of attributes is that they can be designated as being anonymous. In this case, applications 61 cannot read in the specific value of an attribute from a specific user, but they are nevertheless able to receive statistics relating thereto. Thus, if a location was designated as anonymous for an application, this application cannot read in the location of a specific person X, but it can nevertheless receive a statistic of the type “20% of your users live in a town Y”, which forms particularly useful information for the application owner 63, and is then also a trump card of this management system L.

Different functions can be performed here by the system 2 in respect of the applications, namely first an authentication function: if an application calls on this function, the user is authenticated by the system 2 in the use of one of his conFig.d devices 53. Provided that this runs successfully, the application is notified and will then give access to the user 3.

Furthermore, there is the attribute function: an application can retrieve the attributes 52 of the user and use the values thereof in its commercial operations. Attributes can only be read in on condition that the user 3 has given his express permission to this effect.

There is also the data function, wherein an application 31 can push attributes 52 to the profile of the user 3. In this case, these attributes can be used by other applications 32, 33, 34, provided that this is permitted by the user and the supplying application.

For the end user, the advantages in the use of the management system 2 lie in a noteworthy strengthening of his accounts, the functions and the attributes and also a stronger control over his identity 40, seen from management, confidentiality and security perspectives.

For this application, more specifically the owner 63 thereof, the advantages lie primarily in device autonomy, stronger identities with higher quality profiles, simplified registration and user management, simplified legal and confidentiality compliance. This furthermore also permits a new use of the partner of the user of the application. Moreover, it also permits a lowering of the access threshold to the application. Furthermore, it underpins marketing schemes by the reading-in and provision of attributes to or from partner applications.

In the authentication process, an authentication flow 71 takes place which propagates according to arrow direction F via an authentication path visualised in FIG. 7 in the form of an identification pipeline 70. In order to be authenticated, the user 3 moves through various stages of the flow 71, wherein each stage provides specific guarantees to the agent or customer application. The successive steps of the authentication process are explained below.

In a first step referred to as the device selection A, the user 3 is prompted to select the authentication means 53 that he wishes to use for authentication purposes. In this way, the user can select this means 53 which he has to hand or which suits him best at that time and at that place. However, this means selection A can be restricted at the request of the application, for example only stronger authentication means for high-value transactions.

The authentication then takes place B, as required by the relevant device 53.

In the following step, which is the one of the agreements C, a general legal conformity is confirmed by asking the user 3 to express his agreement with regard to a user agreement C. This step occurs only if a new version of the user agreement is available.

Furthermore, the management system 2 asks the user 3 whether he is in agreement with the relevant application 61 using specific attributes 52. This is therefore the confirmation step D of the attributes which are determined by the aforementioned operator 65. The core L asks this once only, so that in subsequent authentication events, this step D will not occur, except if the application attribute requirements have since changed.

Finally, there is the comparison step E, where the core L compares the user attributes with the attributes retrieved by the relevant application 61. Some attributes can be designated as requested. However, in the event that the user is not provided with these attributes, the management system L will first ask the user 3 to obtain the attributes.

The authentication flow 70 described above can be incorporated into various protocols. Unless otherwise notified, this is the protocol SAML, version 2.0, for the present management system.

As far as the authentication means 53 are concerned, some of these are supported in a dynamic manner by the management system 2. These elements 53 are not hard-coded in the management system 2, so that new authentication elements 53 can be added without the need for new software for the management system 2. For each authentication element 53, the management system 2 knows the location of the registration/update/deletion and authentication workflow 70. These workflows are jointly determined by the management system operator 65 and the device provider 64. These workflows 70 differ for each device 53, given that there are differences in both the technology and the delivery procedures.

The software that implements these workflows can be accommodated and processed by the management system operator 65 or by the equipment owner 64. This choice depends on a number of factors, such as security, costs and experience. In any case, the management system can use workflows from remote elements, which can be developed and maintained separately.

For a number of strongly regulated authentication elements, the operator 65 of the management system 2 does not require much cooperation from the element provider. A good example of this is the large PKI-based electronic identity card.

As an example, a number of technical choices are set out below in relation to tools and means that are used, which must similarly not be regarded as limiting in this context. The management system 2 designated as LinkID is implemented in Java EE 5 and is independent of both the operating system and the database.

This management system uses only open standards, in order to ensure maximum compatibility with the customer applications, namely SOAP, WS-Security, Liberty Alliance, SAML, X.509, etc. A Java SDK is jointly developed with the management system in order to simplify the integration between applications and the management system. However, this does not mean that applications that have been written in other languages have been cast aside. Given that all communication runs on open standards, it is easy to extend the SDK to other languages, wherein this is only to be regarded as a reference implementation.

The management system according to the invention has been built on an extremely flexible architecture in order to make it technology-independent. All technology-dependent components are plug-ins and can be extended. The following characteristics have been developed in this way and can thus be extended: among the authentication means 53, mobile authentication, EMV cards, OTP tokens, etc. As far as authentication protocols are concerned: Cardspace, OpenID, windows live ID protocol, Shibboleth.

In an advantageous manner, the implementation of a signature service is similarly provided. If this service is used, an application 61 can ask the management system 2 to arrange for a user to sign a specific document or transaction with the use of his authentication elements 53. In this way, an application can use the management system 2 to strongly seal transactions in a technology-independent manner in perfect accordance with legal conformity.

If different LinkID instances are in production in different regions or industries, possibly being processed by different operators, the operating system 2 will have the facility to allow users 3 to move between these instances. Users who are connected to one management system 2 will be able to use applications that are connected to a different LinkID instance.

An overview of the advantages produced by the LinkID management system 2 is presented below. Thanks to this system, the agent or service provider can do more with the users. In this respect, application providers have a requirement for management systems that involve a larger number of users, with more applications and ultimately more revenues. This management system offers a reliable authentication which covers all the requirements, by offering their users an identification management in which they can trust.

This is done by acquiring deeper and broader levels of commitment from its user base, by allowing trust and control to be increased. Membership levels with simple management and transactions in one click intended for a migration to premium services also come into consideration here. Moreover, traffic and use increase, given that users find it more convenient and more productive to manage their use by means of one single ID which they control more effectively and can trust.

An example of a system set-up is described on the basis of the relevant FIG. 8, in which an identity service is presented, with one single identity number 80 which is confirmed by the system 2. This system service extends the internal identity management of the service provider to external partners. This service allows users to move freely between the agent or service provider and its partner applications, and furthermore also simply allows sharing of personal and marketing data.

This identity number service eliminates the need among specific users to take advantage of their partnership between service providers. This similarly allows exposure of service provider applications and customer data to external parties.

Application examples which can provide the sharing of the advantages or profits are known as co-branded services from the physical world, or the possibility for the sharing of payment or trusted systems between applications.

The system offers a number of important characteristics in cases where the customer is located outside the service provider area, namely in the domain of user convenience; no further need to arrange re-registration in the domain of confidentiality control, the customer can decide which data can be read in by external parties in the domain of standard interfaces for partner applications; and furthermore, in the domain of simple and reliable authentication, wherein the customer can choose from the suitable and reliable devices without the slightest integration problem for the partner application. Existing external authentication means 53, such as eIDs already used or pairs of usernames/passwords 82 can be re-used 83.

Said identity system thus becomes the integration point for external applications as clearly presented in FIG. 8, where this identity number system 80 assumes a central position in the graphic, around which everything revolves, and thus acts as a type of central processing unit for the above. However, it could even be used for new or existing applications.

A strong authentication is then to be regarded as the advantage of the system according to the invention, wherein the access to an account of a management system 2 can be protected with the use of a plurality of authentication means 53 which differ in complexity and reliability. This offers a large number of advantages.

First of all, an online application may include a strong authentication if needed, for example if it is based on a transaction value. However, if a strong protection is not strictly necessary, simpler authentication methods can be used, in other words the reliability level of the authentication means 53 can be adapted to the required application 31, 32, . . . ; 61.

Furthermore, users 3 can use an authentication method as a back-up for a further method: if one method is unavailable, the user can fall back on a different method thanks to this characteristic.

Moreover, the authentication system L is completely deployable; it can at any rate support any proposed authentication mechanism and can also offer this as an authentication method to its account holders.

Authentication methods are e.g. a mobile telephone, wherein different technologies are available, notably SMS, software on the telephone or PKI on the SIM card; with password 82, wherein the management system 2 similarly supports normal username/password combinations, either as a stand-alone database or linked to an existing user base; furthermore, also an electronic identity card, wherein the management system 2 already supports the PKI electronic identity cards, i.e. presently the Belgian electronic identity card; and finally also a digipass 86, wherein the management system 2 already supports implemented digipass solutions. This digipass means 86 is available to users to certify all applications or a restricted number of applications, according to the policy adopted here by the operator of the base installed with digipass.

For the user registration, customers can obtain an account in two ways. They can either create their own account themselves, or an account is automatically converted or mirrored from an existing identity system.

In both cases, the account of the management system 2 will grow with time. The customer, agent or service provider and its partners will add data to the account. New authentication means 53 are incorporated along the way as they become available or are required for a specific application 61.

The end result is then a particularly rich account that can be used in any given commercial condition as long as all information relating to the user 3 is present and he can be identified to the extent that the new application requires. The account can then be extended into new applications without delay due to technical interfacing issues or user registration obstacles.

In short, the management system according to the invention is an appropriate means of capturing the information value of the customer file and making efficient re-use thereof.

An additional extension of the functionality of the LinkID management system according to the invention referred to as L is explained below, consisting in the development of an additional contrivance referred to as the “red button”. This essentially involves an activation means of a specific application in a specially designed format that is described below in connection with an application example in a TV broadcast.

In this format, a LinkID application is installed on a mobile terminal of the user, which may be any given mobile device that is capable of running third-party applications. Examples of this are an iPhone, an iPad, Android devices, etc.

The aforementioned application has a distinguishing logo and brand, which identifies an identity provider. In the TV world, the latter may be a broadcaster, a cable network, a media group, or an advertiser, etc.

If this logo appears in a LinkID or “L”-activated TV programme or advert, the user can activate this logo by pressing it on his mobile terminal.

The L application starts up and downloads interactive content relating to this advert or TV programme from an L server, which then decides which content to broadcast, based on the time when the interactive content was requested.

This content comprises normal multimedia information material, but also actions that the user can undertake. If required, a part of these actions and content can be exclusive and specific to the user of the L application and could, in other words, not be obtained by, for example, surfing on the broadcaster, the television station or the advertising website.

A typical example of exclusive action consists in a price reduction which is offered to the viewer.

The exclusive content and privileges can be immediately used via the L mobile application, or can also be used later, similarly via the L mobile application, or via a website, or also a point of sale (POS).

In order to install the aforementioned mobile application, the relevant L format requires the installation of a telephone application on the telephone terminal of the user.

A marketing campaign must convince the users to download the application free of charge from their mobile shop.

When the LinkID application is started up for the first time, the user can create an account, including a chosen account name, and may optionally choose a PIN code, again via the mobile L application. The mobile device is connected to the account that has just been created, so that any action that is carried out via the mobile terminal is charged.

The synchronisation of the content takes place as follows: if the user presses on the aforementioned logo on his mobile terminal, specific content for the user is displayed, given that the application owner must be aware of the content that appears when a user presses on the aforementioned logo on his mobile terminal, the Link-ID application must be synchronised with the TV content. Given that a collaboration takes place between the producers of the TV programme or advertisers and the management system 2, it is known roughly when these begin.

The synchronisation is obtained with the activated TV programme and at least one of the following techniques: the core L is automatically informed when the programmes or adverts activated with the core begin; the core L itself detects the beginning of a TV programme or advert that has been activated with the core L with a touch of the screen; and/or the core L is manually conFig.d by an operator.

In the event that different TV programmes or adverts activated with the core L occur simultaneously, the core L will simply ask the user to choose which content he wants to see, or which channel he was viewing.

The sequence of the content is as follows: when a user has activated a Link-ID application by pressing on the selection means provided for this purpose during an activated or provided television programme or advert, he has the facility to visualise a specific content or to perform specific actions.

In addition, the core will indicate to the account of the user that he has pressed the relevant selection means or button in a specific programme or advert, the user can then transfer to a website of a producer or advertiser subject to use of his PC or mobile means and he can then further log in using his mobile application.

The website can then ask for the account of the user and check whether he has joined the current system campaign. If so, the website can give special privileges to the user.

Simultaneously all required personal particulars of the user are shared with the producer/advertiser. If privacy legislation and regulation so requires, this data sharing can be carried out in such a way that the user must expressly confirm this.

The user can also claim his benefits on a point of sale POS provided that the POS software is connected online. To identify himself, the user can notify his core system, username—chosen by him on registration—to the POS operator, or he can have a barcode and the like generated by a system mobile application.

The POS software can then scan this barcode or TAG and further use it to identify the user in the system server.

Application examples of the system button are particularly in the following possible conditions by pressing the system button during an advert thanks to which the user can enjoy an exclusive price reduction on the advertiser's web shop.

Furthermore, by pressing the button various times, the user can obtain a benefit if he views all parallel-running adverts of a specific product. This means also allows a vote to be placed during a TV programme in the context thereof, in a poll. Finally, pressing the system button during a TV programme can provide additional content known as a bonus, or additional background information on the subject concerned.

In the context of a further extension of the functionality of the management system, a further development of the possibilities of the attributes is also explained below in FIG. 10.

Wholesaler Deal Community case

The following presentation should be regarded as an impetus and input to the set up of a “Wholesaler Deal” service based on the above proposed L solution, which refers to the reference “Mobile Wholesalers, the community operator who facilitates ‘deals’”.

Hereinafter, a brief overview is presented of the possible configuration, use cases, development as well as method and planning to achieve set up, implementation and use of the Wholesaler Deal service. The L 4 steps as indicated is used herewith.

1. Wholesaler Deal configuration

For the sake of clarity, only the most important functional connections are shown in the circuit diagram in FIG. 10.

Wholesaler Deal web site

This is the Wholesaler Deal community web site wherein users can i.a. register themselves, search deals and offers, and buy or acquire.

As soon as a voucher is purchased on this site, it is passed to the L promo web service. Also credits that are earned during this purchase, or other actions on this site, are passed to the L promo web service.

Partner Shop (POS)

This is a local trader in a Point of Sales (POS), i.e. a physical store. This trader can claim and grant vouchers and credits through the linkID promo web site, the promo linkID web service, e.g. linked to the cashier system, or via a mobile merchant app.

Partner web site

This is a web shop that participates to Wholesaler Deal. It can claim and award vouchers and credits through the L promo web service or L promo web site. Also the Mobile Wholesalers web site is regarded as a partner that participates to the Wholesaler deal.

linkID is the identity provider that provides i.a. for authentication and identification of users in all other components, management of attributes, user registration, profile/attribute sharing, logging, auditing, . . .

Promo linkID attribute provider IF

This is the interface between the promotions and deals and the L attributes system. The attributes that can be derived from the “deals” situation of the user are e.g. “credential” in terms of deals or credits and loyalty levels.

linkID Promo Model

This L program implements various types of promotions based on give and take. It keeps track of which parties can give and which parties can take, and how much. It also keeps track of how much “credits” someone has from which promotions. The L promo model is a model for virtual cash. There are tracked amounts of certain currencies by user. The currencies are i.a. vouchers, points, . . . The linkID promo model also knows what currencies, namely vouchers or points are applicable in which applications, and also which applications these currencies may award or consume and whether any interaction or confirmation from the user is needed thereby.

In the linkID Promo model, credit systems can be expressed as universal credits and local credits, but also vouchers for all sorts of deals.

linkID Promo transaction WWW

This website has a dual function, viz Website where traders/merchant can assign credits in a POS if a user has earned it or claim it if the user has consumed it. This web site may also be used during a transaction on a web shop. The web shop then sends the user on to this promo site where the “payment” is done using credits.

linkID Promo transaction WS

This web service allows merchants, web shops and Wholesaler Deal web site promos to award or claim promo's from other systems.

linkID Promo merchant mobile app

This is mobile device app that can be used by the trader instead of the promo transaction web site for claiming and awarding promotions.

linkID mobile app

The linkID mobile app has several features: a 2-factor authentication for linkID, selection and use of vouchers, and finally an interface to the Wholesaler Deal web site. The 2 factor authentication means that the user can authenticate himself quite safely by using his smart phone at all connected online partners as well as on the Wholesaler Deal web site.

The application is also used when claiming vouchers, the user selects the vouchers that he wants to offer to the trader. The app is a native GUI for the end user aspects of the linkID Promo WS, namely the use of vouchers.

Optionally, the app may also be used for buying vouchers, in which case the app functions as a native GUI for the Wholesaler Deal web site.

Mobile Wholesaler web site and API

Mobile Wholesaler offers an API allowing Mobile Wholesaler Users to be used easily in the Wholesaler Deal community.

Mainly the username/password of the Mobile Wholesaler Site is then reused. In addition, the reuse of some personal may also promote migration. This offers the possibility to Mobile Wholesalers users to log on the Wholesaler Deal site also through their Mobile Wholesalers UN/PW.

However, new users of Wholesaler Deal have to register again and authenticate each time at the Mobile Wholesalers site. If the “integration or interoperability” between the Mobile Wholesalers and linkID is further elaborated as shown in the document linkID/Mobile Wholesalers set up, then new users of Wholesaler Deal may logon with their Wholesaler Deal ID as well to the Mobile Wholesaler Site, using multiple authentication means as yet indicated above.

Payment Service Provider (PSP)

The PSP is the party making the payment. Where possible, the latter too uses the Wholesaler Deal ID of the user, in order to quickly retrieve last payment data, and thus ideally enabling a one click payment.

2. Use Cases

Hereinafter some typical use cases for the Wholesaler Deal system are briefly described by way of example. For each of these use cases, it is identified which elements perform which roles. These use cases show only a few possibilities of use of the Wholesaler Deal service. Other possibilities include i.a. the share of “credits” among users, the use of promotions between affiliated partners, . . . The basic use cases for the Wholesaler Deal service are further defined and specified as shown in Process (step 1 and 2).

Use Case “Buying a restaurant voucher”

At the Deal Wholesaler web site, a voucher for a dinner is offered at an attractive price. The user of Deal Wholesaler logs in. For this, he is sent to the linkID service that authenticates him by using a mobile device, SMS, eID or password. After authentication, the user is returned to the Wholesaler Deal web site. On the basis of its attached information, the Wholesaler Deal site is able to recognize the user.

The Deal Wholesaler user clicks on the “buy now” option, next to the voucher.

The user is redirected to the Payment Service Provider for completing the payment. The PSP also receives the linkID identity of the user. Based on this identity, the PSP takes the last payment data, and it offers the user the opportunity to work with 1 click to confirm the payment.

The user is sent back to the site Deal Wholesaler with a payment confirmation. The Wholesaler Deal site contacts the Promo backend via the Promo transaction WS, and adds this way a restaurant voucher to the account of the user.

The user goes to the restaurant and enjoys the meal. Upon payment, he lets know that he pays with a voucher. The user takes his mobile device and launches the Promo app. He seeks the voucher In the promo app, and clicks on “offer”. A reference appears on the LIN.K-Wholesaler Deal Community smartphone. The user shows this reference to the restaurant staff.

The employee opens the transaction Promo web site, the Promo mobile merchant app or the Promo transaction WS, through his POS, and he sees all “pending, active” restaurant vouchers, generally only a few, that are originating from all persons wishing to pay at that time with the voucher in that restaurant. He seeks the voucher with the same reference as the one shown by the customer. He clicks on “accept” at the appropriate voucher.

In this use case, the user has of course other possibilities as well, in addition to his mobile to offer the voucher, e.g. print out.

Use Case “Online discount through credits”

When purchasing products from Wholesaler Deal partners, the user can earn credits. He can also earn these by purchases on the Wholesaler Deal site itself.

The web shop A which awards the credit, states the identity of the user through linkID.

The web shop A contacts the Promo backend via the Promo transaction WS and adds the credits to the account of the user.

The user goes to web shop B and selects a product. Upon payment of the product, the purchaser gets the opportunity to pay partially or fully through credits.

Web shop B sends the user to the Promo transaction web site. This site recognizes the user and requires only a confirmation from the user for the use of X credits.

After confirmation, the Promo transaction web site sends the user back to web shop B. The outstanding balance is further settled through a payment process with the PSP, which ideally also includes just one click.

1. Device for providing an authenticated access to the Internet based services, characterized in that it comprises a unified identity management system (2), which is centered on the user (3) for generating a unified identity means (23) intended for users (3) within a particular area, so that this user is able to use the same account to make himself known and to authenticate this for various applications (31, 32, 33, 34, 61), possibly based on different application owners (63).

2. Device according to the previous claim, characterized in that the user centered management means (2) is based on a combination of validation means of agreements established between a particular service provider and owners of the concerned websites in their capacity of suppliers, to provide access for the user (3) to an Internet site he visits that is subject to the intended management system (L) when he is connected to the relevant management system (L).

3. Device according to any one of the preceding claims, characterized in that the management system (2) is aimed at the user (3), whereby the latter is able to access all of the aforementioned applications (31, 32, 33, 34) which are mutually different, and this by means of a single identity field (40) which the said user (3) unequivocally identifies, wherein said centered linked identity management system (2) provides a unified identity field (40) to the user (3) that is used for the said applications (31, 32, 33, 34) at the same time, and which is operated by multiple application holders (AA, BB).

4. Device according to any one of the preceding claims, characterized in that the globally unified identity field (40) is inserted by the user (3), which is identified by the said one globally unified identity (40), in order to have access to its desired applications (31, 32, 33, 34) which are operated by agents (AA, BB).

5. Device according to any one of the preceding claims, characterized in that the unified identity (40) that is generated by this system (2) consists of four different components (51, 52, 53, 54) all of which are connected via the core element (L), wherein the first of the abovementioned identity components (51, 52, 53, 54) consists in so-called attributes (52), which consist of pieces of data that are assigned to the physical person having the relevant identity, in his capacity of user (3);
wherein a further component consists in accesses (51) that determine to which of applications (31, 32, 33, 34) the corresponding identity (40) can be used, and which (51) form the link between an application (31, 32, 33 , 34) and an identity (40), and which control certain legal and confidentiality requirements between a user (3) and an application (31, 32, 33, 34) which the latter wishes to set up;
wherein a still further component consists in authentication means (53) in order to be recorded and used by the user (3) in order to authenticate himself, where a given identity (40) has recorded several authentication means (53), and finally, the history component (54) in which the user (3) keeps a track of all the actions in connection with his identity (40).

6. Device according to the preceding claim, characterized in that the various authentication means (53) are used to achieve access to the said Internet site that is connected to the management system (L).

7. Device according to any one of the preceding claims, characterized in that some of the control management means are provided with attributes (52) that are intended to determine the profile of the user (3), wherein control means thereof are provided in the management system (L) to take out the said attributes (52) and store them (52) during the course of the process (70).

8. Device according to the preceding claim, characterized in that the system (L) constitutes a standard based management system for managing a standard sponsored user-oriented electronic identity (40).

9. Device according to any one of the preceding claims, characterized in that the management system (2) establishes the uniqueness of the user (3) by means of its units (53), wherein the core (L) prevents a physical device from being used for two different accounts related to the identities (40) in this management system (2).

10. Device according to any one of the preceding claims, characterized in that said attributes (52), that constitute the substance of the identity (40) of the user (3), are used repeatedly between different applications (31, 32, 33, 34), wherein the user (3) is enabled to ascertain at any time which application (31, 32, 33, 34) gives access to which attribute (52).

11. Device according to any one of the preceding claims, characterized in that the said attributes (52) possess certain data types, which are linked with single, possibly also multiple values.

12. Device according to any one of the preceding claims, characterized in that said attributes (52) are composed in order to form new data types.

13. Device according to any one of the preceding claims, characterized in that the said attributes (52) are added by the operator (65) upon request of his customers, i.e. the application owners (63).

14. Device according to any one of the preceding claims, characterized in that in the construction of the system (2), the core element (L) thereof takes a central position therein, wherein it communicates with several batches which are defined as
end-users (3) which are formed by physical persons, who have an account and who wish to use applications (61) that are linked to the core (L) of the management system (2), wherein the end-users (3) are interacting with the system core (L) by means of an interface (62),
wherein a further party is formed by the applications (61) which are designed to perform any functions consisting in certain services that are provided to the said end-users (3), wherein they make use of both said core (L) for identifying their users (3) and of web services (62) to communicate with the core (L),
wherein a yet further party is formed by application owners or operators (63) who hold and operate said applications (61), and who are the actual customers of a key operator (64), wherein they get interacting with the core (L) through a web application which provides information about the applications that they possess,
wherein a still further party is formed by the operators (65), which manage the system software in data centers, and which sell the various system functions and services to the said application owners (63), and thereby cooperate with said application own to have their applications (61) connected to the management system (L), and
finally, having the device providers that deliver the required authentication means (53) deliver to the users (3) that have their device (53) borne by the management system (2).

15. Device according to any one of the preceding claims, characterized in that several functions are performed by the system (2) with regard to the applications (61), in particular
at first an authentication function, wherein if an application calls this function, the user (3) is authenticated by the system (2) upon the use of one of its configured devices (53), and if this is successful, the application is notified and at this moment, provides access to the user (3); p1 further an attribute function, in which an application calls upon the attributes (52) of the user (3), and uses the values thereof in its commercial operations, in which the attributes are being read only on the condition that the user (3) gives expressly his permission to do so;
still further a data mode function, wherein an application (31) pushes attributes (52) to the profile of the user (3), in which case these attributes are used from other applications (32, 33, 34), provided that this is permitted by the user and the supplying application.

16. Method for providing authenticated access to the Internet-based services, especially according to any one of the preceding claims, characterized in that in the authentication process, an authentication stream (71) takes place, which propagates according to an authentication path (F), wherein the user (3) gets through different stages of the flow (71) to be authenticated, with each stage awarding certain guarantees to the agent or customer application.

17. Method according to the preceding claim, characterized in that the successive steps of the authentication process are as follows:
in a first step of item device selection (A), the user (3) is offered to choose the authentication means (53) that he wishes to use for authentication purposes, wherein the user selects this means (53) and wherein said means selection (A) gets restricted upon request of the application,
then the authentication takes place (B) as required by the respective item device (53).

18. Method according to the preceding claim, characterized in that the next step consists of the agreements (C) in which a legal conformity is validated by asking the user (3) to express his agreement in regard to a use agreement (C), only when a new version of the use agreement is available.

19. Method according to the preceding claim, characterized in that the next step consists of the confirmation step (D) of the attributes (52) which are determined by the said operator (65), wherein the management system (2) asks to the user (3) if he agrees with the corresponding application (61) under use of certain attributes (52), wherein the core (L), requires this only once, so that in subsequent authentication events this step (D) does not occur, unless the application attributes requirements changed in the meantime.

20. Method according to any one of claims 17 to 19, characterized in that the last step consists of the comparison step (E) in which the core (L) compares the user attributes with the attributes that are called upon by the respective application (61), wherein some of the attributes are marked as required, wherein if these attributes are not available to the user (3), the management system (L) first requires from the user (3) to provide the attributes.

21. Method according to any one of claims 17 to 20, characterized in that the attribute values are provided either by the user himself (3), by an application (61), by a device (53), or by a remote system, such as a database, or also based upon a calculation of other attributes (52).

22. Method according to any one of claims 17 to 21, characterized in that an attribute is read by an application (61) when the following conditions are met, in particular that the operator (65) provides access to the application to the attribute, the user (3) gives permission to the application (61) to use the attribute and, finally that the attribute has a value.

23. Method according to any one of claims 17 to 22, characterized in that several authentication means (53) are supported in a dynamic manner by the management system (2), wherein new authentication elements (53) can be added without the need for a further software for the management system (2).

24. Method according to any one of the claims 17 to 23, characterized in that for each authentication element (53), the management system (2) knows the location of the registration/update/removal and authentication workflow (70), which are determined together by the management system operator (65) and the device provider (64).

25. Method according to any one of the claims 17 to 24, characterized in that the implementation of a signature service is provided, in which the management system (2) can be asked by an application (61) to have a particular document or transaction be signed by a user (3) with the use of its authentication elements (53).

26. Method according to any one of the claims 17 to 25, characterized in that, where several L-bodies are in production in several areas, possibly under processing by different operators, the management system (2) makes users (3) evolve between these bodies, wherein users who are connected to a management system (2) are able to use applications which are connected to another L-body.

27. Method according to any one of the claims 17 to 26, characterized in that the authentication system (L) is completely usable.

28. Method according to one of the claims 17 to 27, characterized in that an additional extension of the functionality of the management system (L) consists of an activating means of a particular application as a specially developed format in which a L-application is installed on a mobile device of the user who is capable to run applications of third parties, wherein said application has a distinctive character that identifies an identity provider, wherein when this sign appears in an L-activated element, the user can activate this character by pressing it on his mobile device, which starts up the L-application, thereby downloading interactive content in respect of said element.
